(19) United States
(12) Patent Application Publication
(10) Pub. No.: US 2018/0052967 A1
(43) Pub. Date: Feb. 22, 2018

(54) MANAGING DATA COMMUNICATIONS FOR A HEALTHCARE PROVIDER

(71) Applicants: Tim Boomershine, Broomfield, CO (US); Francesca Gordon, Jamica Plain, MA (US); Connance, Inc., Waltham, MA (US)

(72) Inventors: Tim Boomershine, Broomfield, CO (US); Francesca Gordon, Jamaica Plain, MA (US); Jake Knoll, Watertown, MA (US); David Franklin, Waban, MA (US)

(21) Appl. No.: 15/560,932

(22) PCT Filed: May 6, 2016
(86) PCT No.: PCT/US16/31317

§ 371 Date: Sep. 22, 2017

Related U.S. Application Data
(60) Provisional application No. 62/158,458, filed on May 7, 2015.

(51) Int. Cl. G06F 19/00

(52) U.S. Cl. CPC G06F 19/3418; G06F 19/3431; G06F 19/324

(57) ABSTRACT

Among other things, we describe a system for managing data communications for a healthcare provider. The system includes a first communication module to receive data representing an identification of a particular patient; a second communication module to receive data representing a model that predicts impact of socio-economic and demographic factors on readmission risk; a third communication module to receive data from at least one system storing data representing a set of socio-economic and demographic characteristics of the particular patient; a fourth communication module to receive data about encounters of the particular patient; and a fifth communication module to automatically transmit data representing at least one message related to identified socio-economic or demographic characteristic to cause a recipient of the message to take an action to affect the one or more socio-economic and demographic factors.

### TECHNICAL FIELD

This invention relates to managing data communications for a healthcare provider, and including managing the communications in a way that affects the management of a patient's health.

### BACKGROUND

Modern healthcare providers use computer networks and data communications to manage the provision of services. Some ways a healthcare provider may use these technologies include maintaining data about their patients, assigning tasks to staff (e.g., doctors, nurses, technicians) electronically, and communicating with patients electronically, including before the patient visits the provider, while the patient is at the provider, and after the patient has left the provider.

### SUMMARY

Among other things, we describe a system for managing data communications for a healthcare provider. The system processes data received from one or more sources of data and transmits output data to one or more output devices, including, for example, devices used by hospital staff or a hospital patient. The system includes a first communication module to receive data representing an identification of a particular patient; a second communication module to receive data representing a model that predicts impact of socio-economic and demographic factors on readmission risk; a third communication module to receive data from at least one system storing data representing a set of socio-economic and demographic characteristics of the particular patient; a fourth communication module to receive data about encounters of the particular patient; and a fifth communication module to automatically transmit data representing at least one message related to identified socio-economic or demographic characteristic to cause a recipient of the message to take an action to affect the one or more socio-economic and demographic factors.

The technology described herein has several advantages. One advantage is that a single system can be used to manage certain kinds of data communication. For example, the single system can receive and process data received from multiple sources, including data received from a healthcare provider (e.g., data such as patient records) as well as data received from other sources (e.g., data such as demographic data supplied by a third party demographic database). In this way, the provider's systems need not manage communication with the other sources, or even be aware of the existence of the other sources, but can still take advantage of the data from those other sources. Another advantage is that the single system can communicate with output devices in a way that benefits the provider, even if there are many output devices and even if some of the output devices are not known to the provider. For example, the single system can transmit messages to output devices used by provider entities such as hospital staff (e.g., laptop computers or tablet devices that belong to the hospital), as well as output devices used by patients (such as smartphones owned by the patients). Another advantage is that data communication can be managed in a way that affects health risks, such as the risk that a patient will be readmitted to the hospital. For example, the single system can use all of the types of data available to it (e.g., data provided by the healthcare provider, as well as data provided by other sources) to initiate communications that are likely to reduce the risk that a patient will be readmitted, e.g., because of a recurrence of a health condition. Further, health risks may depend on some factors known to a healthcare provider (e.g., a patient's health status) as well as factors not necessarily known to a healthcare provider (e.g., the demographics of a patient's neighborhood). For this reason, a single system that determines health risk and initiates further action based on the determined risk can achieve better results (e.g., reduce readmission of hospital patients, improve health outcomes) if the system has access to both healthcare provider data and other kinds of data and uses these kinds of data in the determination of health risk.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system that uses a health risk model.

FIG. 2 is a more detailed block diagram of the system in which data is applied to the health risk model.

FIG. 3 is a flowchart of a process for determining risks that may affect a patient's health.

FIG. 4 is a flowchart of a process for determining health risk and transmitting messages.

FIG. 5 is a flowchart of a process for transmitting messages about actions for reducing stressor index values.

FIG. 6 is a block diagram of model inputs to a health risk model.

FIGS. 7 and 8 represent output messages.

FIG. 9 shows a computer system.

Like reference symbols in the various drawings indicate like elements.

### DETAILED DESCRIPTION

Data communications can be used in a healthcare provider setting to affect health risks, such as the risk that a patient will need to be readmitted to a hospital at a later time, not be compliant with treatment protocols, fail to attend appointments with caregivers, not be adherent to prescription use, or other actions/omissions that affect the patient's well-being. The risk that a patient will not act or fail to act in ways that improve their health depends partially on socio-economic and demographic factors. For example, a patient treated for diabetes who lives in a poor neighborhood may not have access to healthy food and is at greater risk for requiring hospitalization or specialized care than a patient who lives in a wealthy neighborhood. A system can determine a patient's propensity towards these types of risks based on socio-economic and demographic factors and further determine what actions can be taken to mitigate those risks. For example, depending on the particular socio-economic and demographic factors involved, the system may be able to automatically follow up with the healthcare provider or the patient to affect the specific socio-economic and demographic factors.

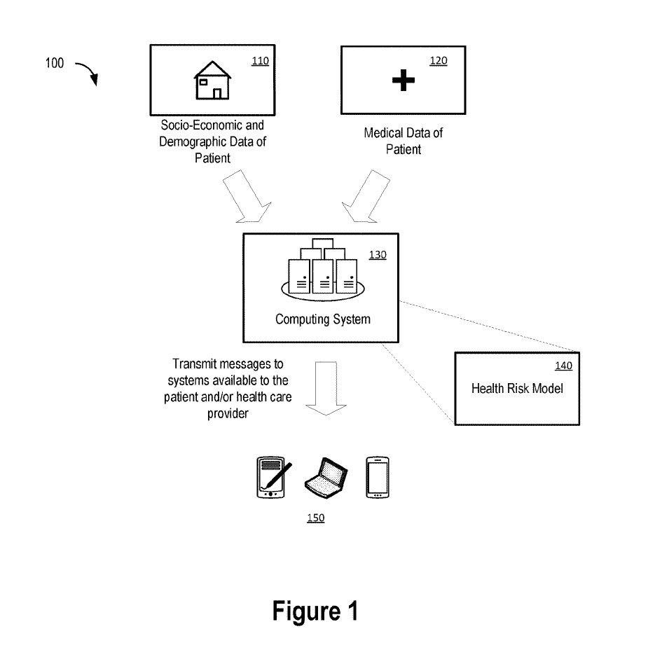

FIG. 1 is a block diagram of a system 100 that uses a health risk model 140 (which we sometimes refer to as a generalized health risk model) in determining what actions to take, e.g., based on calculated generalized health risk values. The system 100 includes a computing system 130 that communicates with several sources of information and applies received data to the generalized health risk model 140. A generalized health risk model 140 applies to one or more different categories of health risks, e.g., risk of hospital readmission, risk of non-compliance with treatment protocols, risk of failure to attend appointments with caregivers, or risk of non-adherence to prescription use.

The system 100 has access to a socio-economic and demographic database 110 of patient data. The socio-economic and demographic database 110 contains data about socio-economic and demographic factors that are specific to patients and that can impact patient healthcare use. The socio-economic and demographic database 110 includes patient information such as names, addresses, income, size of household, number of generations, number of children, number of vehicles, credit attributes, and so forth. Some of this data is at the individual level (e.g., the data has a granularity such that an individual is associated with one or more pieces of data specific to that individual), while other data is specified at another level, e.g., the neighborhood level.

In some examples, the socio-economic and demographic data 110 is not directly available to healthcare providers. By “not directly available”, we mean that typically a healthcare provider would not have access to its own database of socio-economic and demographic data, e.g., a database stored on a computer system operated or administered by or on behalf of the provider. Instead, this data can be obtained from individual patients, the individual patients' households, and/or public and private data sources such as Lexis Nexis, Equifax, government sources (e.g., census data), and so forth. In some examples, the socio-economic and demographic database 110 is stored at one of these sources, and in some examples, the socio-economic and demographic database 110 is an amalgamation of several distinct databases that exist at multiple sources. In this way, in some examples, multiple socio-economic and demographic databases 110 can be used. Sometimes, the socio-economic and demographic database 110 is housed centrally within the data center of a third-party service provider that provides services to the hospital. An example of a third-party service provider is Connance Inc. based in Waltham, Mass.

The socio-economic and demographic database 110 is accessed by way of a communication module. The operation of a communication module is described in more detail below.

In some examples, the providers do not directly connect to the database 110, e.g., by using applications on the system 100 via a user interface. In such situations, the providers can send requests through backend process servers that are capable of communicating directly with the database 110. In some examples, providers can use communication protocols (e.g., protocols defined by a protocol standard) that encrypt, transmit, and decrypt data. One example of such standard communication is through remotely connecting provider requests via secure file transfer protocol (SFTP) or via real-time connection transmitted over the internet both to and from the provider. In this way, communications between devices, such as hospital devices, and components of the system 100 (e.g., components such as the computing system) can be performed in a manner sensitive to security concerns.

Given that socio-economic and demographic data 110 of patients tends to be stable, e.g., the data does not change substantially over periods of time of months or years, a long time-frame of the data 110 is typically used in creating and training the generalized health risk model 140. For example, a two-year timeframe (e.g., the most recent two years of data) can be used to create and train the generalized health risk model 140. Also, using a long timeframe of the data 110, such as two years, in creating and training the generalized health risk model 140 allows the data 110 to be kept as recent as possible to maintain the treatment date and applicable socio-economic data relevance.

The system 100 also has access to a database of patient medical data 120. This database includes medical attributes descriptive of a particular patient during admission, information derived from the medical records of a patient, and financial records of the patient that are available to the provider. In some examples, historical patient medical data (e.g., medical data describing the patient at times in the past, such as hospital admissions for a past health condition that has been resolved) need not be applied to the health risk model when determining a patient's health risk. In this way, providers do not need to have access to a patient's full historical clinical data over a long period of time.

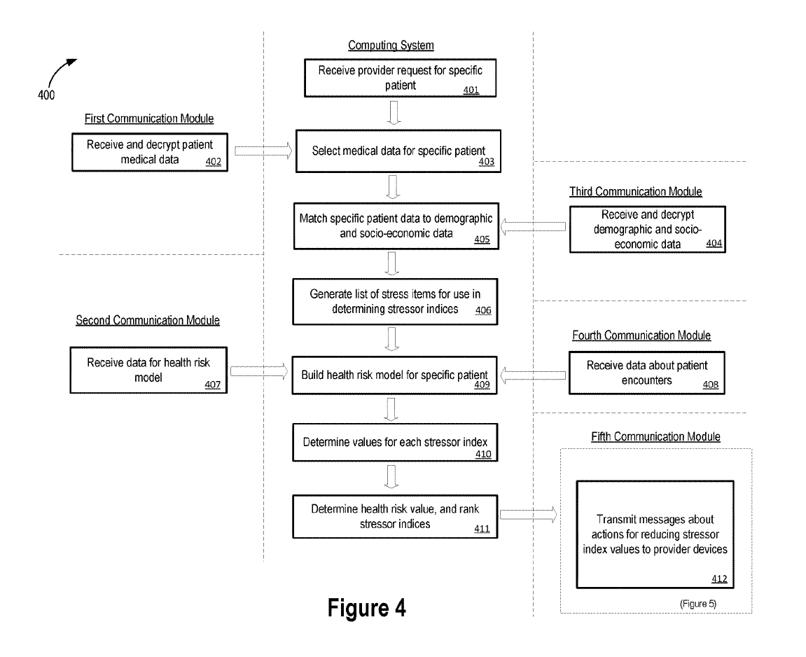

The computing system 130 receives socio-economic and demographic data 110 of a patient and medical data 120 of the patient, and applies the received data to the health risk model 140. By “applies the received data to the health risk model,” we mean that the computing system 130 supplies values for variables of the model. The values are determined based on the received data, e.g., by identifying portions of the received data that are applicable to the model. In some examples, the computing system 130 matches a provider's request for a specific instance of patient data with socio-economic and demographic data and generates specific socio-economic and demographic data attributes to be utilized within the generalized health risk assessment models 140 implemented by the computing system 130. The output of the computing system 130 includes a socio-economic stressor index classification (as shown in FIG. 4, below) ranked on a scale of 1-11, which can be used to generate an overall patient risk classification. Using the computing system 130, changes in the patient's risk classification can be determined based on changes in defined socio-economic stressors that are determined by the generalized health risk assessment models 140.

In some examples, the generalized health risk assessment models 140 apply mathematically-derived socio-economic and demographic-based models to predict the risk of in-patient readmission, using data from patient medical data 120, e.g., clinical factors that are present during admission and discharge of the patient. Because the generalized health risk assessment models 140 use socio-economic data, it may help healthcare providers determine a combination of attributes, specific to a particular demographic or socio-economic group, that when applied to patient medical data 120 causes an increase or decrease in the risk of a health issue, e.g., requiring hospital readmission. Using this information, the system 100 can communicate with hospitals or other healthcare providers in a way that affects health risk.

In some implementations, the model 140 includes associations between socio-economic or demographic characteristics and metrics of health risk. For example, the model 140 may include a variable representing a particular socio-economic or demographic characteristic and an equation that can be applied to the variable (and, in some instances, other variables) to determine metrics of health risk.

As a real world example, the model 140 may include an equation that associates a socio-economic characteristic such as household income with a metric such as expected daily intake of long-chain fatty acids. For example, the equation may be characterized by a correlation between household income and expected daily intake of long-chain fatty acids. Thus, if household income is low, then expected daily intake of long-chain fatty acids may also be low. Further, the model 140 may contain other data that indicates that a low expected daily intake of long-chain fatty acids (e.g., a value of expected daily intake of long-chain fatty acids that is below a threshold specified by the model) corresponds to an increased risk of diabetes-related health complications. The model 140 can be used to identify actions that can be taken to increase expected daily intake of long-chain fatty acids in a particular patient who has been discharged from a hospital after treatment for diabetes-related health complications.

In general, the system 100 causes one or more real-world actions to occur based on generalized health risk calculations. In some examples, the use of the generalized health risk models 140 allows the system 100 to enable healthcare providers to take practical steps for reducing the risk of readmission for particular patients. In this way, the healthcare providers or their representatives can work with high-risk patients towards reducing in-patient readmission.

In some examples, the system 100 determines information of particular relevance to the operations of a healthcare provider, e.g., a list of patients that require actions and the list of actions to be taken for specific patients, messages about the actions to be taken for specific patients, the overall generalized health risk for specific patients, a ranking of stress items (as shown in FIG. 4, below) for specific patients, and so forth. In some examples, the system 100 generates output messages that are sent to provider devices 150. In some examples provider representatives (nurse, doctors, and so forth) take action as needed for each patient care case in response to viewing the output.

In some examples, the output of the system 100 may include a list of actions to be taken by a specific patient, messages about the actions to be taken by the patient, a ranking of stress items for the patient, and so forth. In some implementations, the output of the system 100 is then sent to one or more patient devices, so that the patient can take necessary action to reduce generalized health risk.

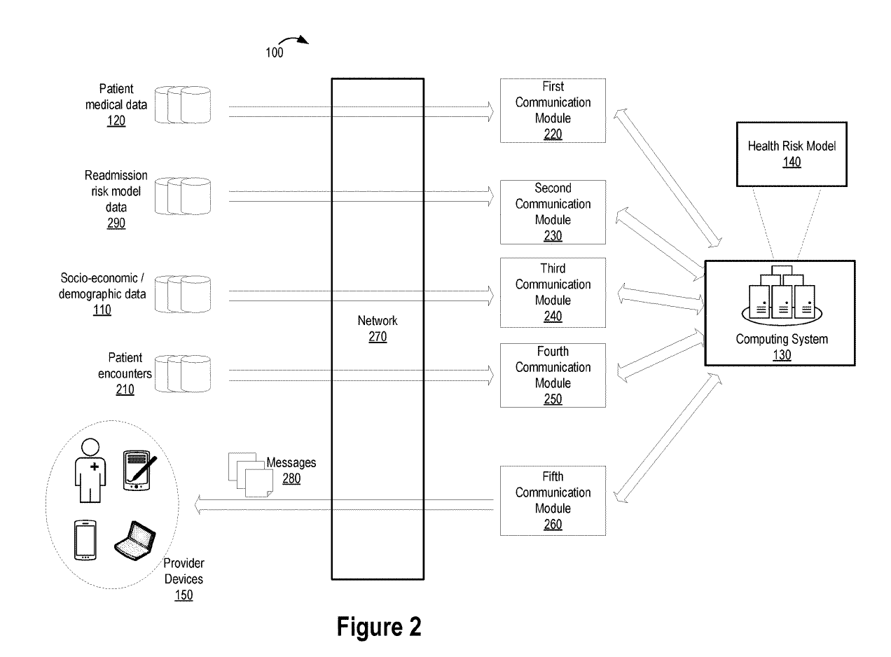

FIG. 2 is a more detailed block diagram of the system 100 in which data is applied to the generalized health risk assessment models 140 to determine generalized health risk and initiate data communication in a manner based on the determined health risk. The system 100 has access to a database of patient medical data 120, a database of socio-economic and demographic data 110, and a database of patient encounters 210. The database of patient medical data 120 includes medical attributes descriptive of patients during admission, information in the medical records of patients, and financial records of the patients that are available to the provider; the socio-economic and demographic database 110 includes data about socio-economic and demographic factors that are specific to patients and that can impact patient healthcare use; and the database of patient encounters 210 includes records of a patient's visits to the hospital. The records in the database of patient encounters 210 may include admission/discharge dates, diagnosis, procedures, types of visits (e.g., whether inpatient, outpatient, or emergency room visits), total charges, and insurance information provided by the patients. These records of patient encounters 210 are applied to the generalized health risk assessment models 140 on the computing system 130 (as shown in FIG. 4, below).

Each of the databases is connected to a communication module that is an interface configured to receive data. For example, the communication module could be a computing system that can receive and transmit data, or a portion of a computing system, or a process running on a computing system, or one or more dedicated standalone devices that can receive and transmit data, or another kind of interface, or any combination of these things. In some implementations, a communication module includes executable code for accessing databases, e.g., executable code that generates a query such as an SQL query to cause a database to return data to the communications module. Each communication module 220, 230, 240, 250, and 260 is in communication with a network 270, such as a local area network (LAN), wide area network (WAN), the Internet, or a combination thereof.

A first communication module 220 is configured to receive data from a database of patient medical data 120; a second communication module 230 is configured to receive generalized health risk assessment models data 290; a third communication module 240 receives data from the socio-economic and demographic database 110, and a fourth communication module 250 receives data from the database of patient encounters 210. These communication modules transmit the received data to the computing system 130 via the network 270.

The computing system 130 is connected to the network 270 and receives, via the network 270, a request from a provider (e.g., hospital) for a specific instance of patient data in the patient medical database 120. In some instances, as could happen in the real world, the entity that operates the computing system 130 also hosts or has access to the all of the hospital's patient medical data. In some examples, the request is a request for generalized health risk, and in some examples, the request is a request for the computing system 130 to provide all of a patient's data to a hospital.

The request may be initiated by the provider (e.g., hospital) and may include, for example, the name and address of a specific patient. In some implementations, a patient and associated socio-economic and demographic information can be determined using a name and address, even if other information is not available. An example of data contained in a request is shown below:

First Name:
Last Name:
Middle Name:
Address 1:
Address 2:
City:
State:
ZipCode:
Provider ID:
Request Date:

The computing system 130 also receives data from the socio-economic and demographic database 110, data about patient encounters 210, the specific patient's medical data, and the generalized health risk assessment model data 290 via communication modules 240, 250, 220, and 230 that are connected to the network 270. Using some or all of these data, the computing system 130 matches the data about patient encounters 210 and the socio-economic and demographic data 110 to the specific patient's medical data, and applies this information to the generalized health risk assessment models 140 within the computing system 130 to evaluate generalized health risk, determine a generalized health risk value, and rank stress items (as shown in FIG. 4, below) for the specific patient.

The computing system 130 transmits messages 280 that include the output of the computing system 130 to a fifth communication module 260. The messages may be intended for a device at a hospital (e.g., to be viewed by a member of the hospital staff, or by a patient in the hospital), or for a device outside of a hospital (e.g., a message to be read by a patient after he or she has been discharged from the hospital). The output of the computing system 130 includes, for example, a list of patients that require actions and the list of actions to be taken for the patients, messages about the actions to be taken for the patients, the overall generalized health risk for specific patients, and a ranking of stress items (as shown in FIG. 4, below) for specific patients. In some implementations, the fifth communication module then transmits the messages 280 to hospital devices 150, so that provider representatives (nurses, doctors, and so forth) can take action as needed for each patient care case. In some implementations, the fifth communication module transmits messages 280 to a patient device, such as a patient's mobile phone, computer, or tablet device, e.g., by text message, email message, or using a custom application (“app”) specific to hospital messages.

In some implementations, for example, the computing system 130 may have access to a database of messages that correspond to specific values of health risk classification for patients. In such a use case, if the health risk is quantified on a scale of 1 through 11, a message may correspond to specific values, such as 1 through 3, or 9 through 11. In some examples, the computing system 130 may identify a message to send to the hospital, e.g., for a particular patient, or to a device of the patient. For example, the computing system may determine that a patient suffering from type-2 diabetes has a high readmission risk (a particular kind of health risk) based on factors such as lack of access to healthy food, lack of access to exercise facilities, lack of access to transportation, and so forth, identified from one or more of the patient's medical data, socio-economic and demographic data, and patient encounters. In some examples, based on the health risk, the computing system 130 may send messages to a device of a nurse or doctor to take actions such as: follow-up with the patient after discharge to remind the patient to make good lifestyle choices such as exercising and eating healthy food, set up an in-home visiting nurse service for the patient, set up delivery of healthy meals to the patient's residence, and so forth. The computing system 130 may also send messages directly to a device of the patient. Such messages may include appointment reminders, discharge instructions for the patient to follow, medication reminders, and so forth, all aimed at reducing the risk of readmission of the patient.

In some implementations, a message is also associated with a modifier value. For example, a message may be associated with a modifier value of −2 (minus two). If the message is applied to a patient identified as having a current readmission risk of 5, the message can be chosen for transmission to a device available to that patient, and can be expected to reduce the patient's readmission risk to 3. In some implementations, a category of messages (e.g., prescription refill reminder messages) is associated with a modifier value, e.g., such that the change in readmission risk is likely to occur if one or more messages of that category are used. In some implementations, a sequence of messages (e.g., weekly reminders to increase physical activity) is associated with a modifier value, e.g., such that the change in readmission risk is likely to occur if the sequence of messages are transmitted over time. In this way, in some implementations, a modifier value can be associated with data (e.g., data of the readmission risk model) representing an activity of a patient (e.g., prescription refill, ongoing exercise, etc.) that occurs after the patient is discharged from the hospital.

In some implementations, only some messages can be used with some output devices. For example, if a message having a modifier value of −2 includes video data (e.g., an .AVI file), and an output device for which the message is destined does not have video playback capability, the message may not be chosen for transmission. Instead, a text-based message having an associated modifier value of −1 may be chosen, e.g., if the output device has text display capability. As another example, a device may be an audio output device, and can only accept messages formatted as audio, and so only audio messages will be chosen to transmit to that device, regardless of their modifier value.

In some instances, the computing system 130 may identify the risk of readmission while the patient is admitted in the hospital, so that programs and resources to reduce the risk of readmission are identified and implemented to set conditions for optimal discharge of the patient. Other times, the computing system 130 may identify readmission risk on discharge of the patient from the hospital in order to update the risk factors that may have been previously identified. In some other instances, the computing system 130 may identify a generalized health risk for a patient that is visiting an outpatient facility, to identify programs or resources that can address the risk factors and avoid preventable admission of the patient to the hospital.

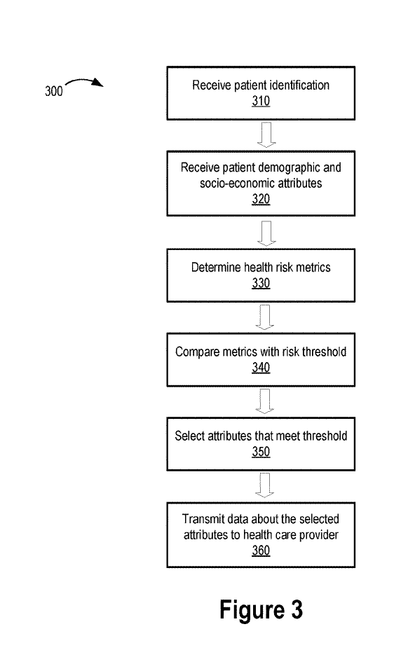

FIG. 3 is a flowchart of a process 300 for determining generalized health risk and transmitting data about socio-economic and demographic attributes that contribute to patient health to provider devices for patient care. At step 310, the computing system 130 receives information identifying a specific patient. In some examples, this information contains the first name, last name, address, and so forth of the patient. The information may be received in response to a request by a hospital or other provider for a specific instance of patient data and used for matching the specific instance of patient data to socio-economic data.

At step 320, patient demographic and socio-economic attributes are received from the socio-economic and demographic database 110. The socio-economic and demographic database 110 contains data about socio-economic and demographic factors that are specific to patients and that can impact patient healthcare use. The computing system 130 then matches the information received from the socio-economic and demographic database 110 with the specific instance of patient data and applies the data to the generalized health risk assessment models 140.

At step 330, generalized health risk metrics are determined for the specific patient. In some examples, the generalized health risk assessment model 140 is used by the computing system 130 to generate values of socio-economic stressor indices. The computing system 130 then aggregates these with customized or standard clinical risk indices to determine risk values, e.g., on a scale of 1-11, that are used for automating the identification of higher risk patients and interventions (e.g., changes to the provider workflow) to reduce the potential risk.

In some examples, the socio-economic stressor indices are determined based on stress items or stressors. These stress items include, but are not limited to financial state, housing stability, household support, food access, transportation access, primary care access, and neighborhood risk. In some examples, the socio-economic stressor indices are derived by the computing system 130 based on the results of a socio-economic or demographic model that utilizes attributes related to a specific type of socio-economic or demographic component of the patient.

In some examples, the clinical risk indices are specific grouping and labeling of patients using risk determined by a clinical risk model that is based on future use of healthcare facilities determined based on clinical information available to the healthcare provider. The clinical information includes, but is not limited to, visit-level data collected by the healthcare provider based on case observations that occur within the provider's facilities. For example, the clinical information may indicate whether a patient had a heart attack, a patient's blood pressure, and so forth.

In some examples, the clinical index is considered the baseline index and is utilized to order patients by risk, and to set breakpoints that define risk groups on a scale. This information is then integrated with the socio-economic indices to determine 330 the generalized health risk metrics. In some implementations, the generalized health risk of a patient is classified on the scale ranging from 1-11, with 1 indicating the lowest risk and 11 the highest risk.

At step 340, generalized health risk metrics are compared with risk threshold values. In some examples, the risk threshold values are based on the model to which the data representing the set of socio-economic and demographic characteristics of a specific patient was assigned (e.g., the risk model 140). In some implementations, the risk threshold values are included in data of the model. In some examples, the model may include one or more data files storing the risk threshold values. In some examples, the risk threshold values are calculated when data is assigned to the model.

At step 350, socio-economic attributes that meet the risk threshold values are selected for a specific patient. In some implementations, if an attribute is associated with a risk value that does not meet an associated risk threshold value, the attribute is flagged for an action that will mitigate the risk of the attribute. For example, as described elsewhere herein, the risk affected by the attribute can be modified by choosing actions, e.g., by transmitting messages that are likely to affect the risk. Data about these attributes is transmitted to the provider at step 360.

FIG. 4 is a flowchart of a process for determining generalized health risk and transmitting messages 280 to provider devices for patient care cases. At step 401, the computing system 130 receives a provider request for a specific patient. In some examples, the provider request consists of the name, address, provider ID, and so forth of the specific patient. The computing system 130 receives the provider request at various times, based on the patient's lifecycle. In some examples, the computing system 130 receives the provider request at admission once the patient's socio-economic and demographic data 110 and initial diagnosis are received. In some examples, the computing system 130 receives the provider request when significant changes to the patient's socio-economic data 110 occur, or when significant changes in clinical risk are identified. In these cases, requests are generated to evaluate the impact of changes in the socio-economic data or the clinical risk on patient health. These requests facilitate the planning of activities to prepare for patient engagement. In some other examples, a request is received by the computing system 130 at the start of patient discharge planning to establish post-discharge follow-up activities that will reduce readmission risk for the patient. In other examples, a provider may initiate these requests at any or all of these stages.

At step 402, the first communication device receives and decrypts a database of patient medical data 120. The database of patient medical data includes data that describe patients during admission, information in the medical records of the patients, and financial records of the patients that are available to the provider. The computing system 130 then selects 403 medical data from the database of medical data 120 for the specific patient for which the provider request was received. In some examples, the computing device 130 makes the selection from the database of patient medical data 120 based on the name, address, provider ID, and other information contained in the provider request for the specific patient.

At step 404, the third communication module receives (and optionally decrypts) demographic and socio-economic data from the socio-economic and demographic database 110 and transmits the data to the computing system 130 via the network 270. The computing system 130 then matches 405 medical data 120 for the specific patient to the demographic and socio-economic data. In some implementations, the memory and disk storage of the computing system match the patient's medical data concurrently with each socio-economic data source, and append each of these in computer memory to the provider request.

At step 406, a list of stress items (also sometimes referred to as factors or stressors) for use in determining stressor indices is determined by the computing system 130. These stress items are attributes to be used within the generalized health risk assessment models. In some examples, the stress items include, but are not limited to, financial state, housing stability, household support, food access, transportation access, primary care access, and neighborhood risk. These stress items can be used to determine values for stressor indices that include, but are not limited to, a clinical index, a stability index, a financial index, a food access index, and a transportation index. For example, car registration information for a patient tells us if transportation is a stressor. Every stressor is assigned to a category corresponding to a stressor index, e.g., transportation, food access, and so forth, and each category may have multiple stressors to accommodate for situations where a particular patient may not have data for particular stressors.

The clinical index uses visit-level data collected from the healthcare provider to measure the health risk based on the presence of factors known to affect health risk. The stability index measures health risk based on the presence of social stressors that can act as barriers to healthcare access. In some examples, the stability index is constructed from household-level demographic data such as education, household composition, Zip Code-level health care access, income data, and county-level income statistics. The financial index measures health risk based on the presence of financial stressors that could complicate the ability of a patient to access healthcare. The financial index can be constructed from household-level data about debt burden. The food access index assesses health risk by using census-tract level food desert data to measure whether a patient has access to nourishing food. Finally, the transportation index calculates generalize health risk based on whether an individual has access to reliable transportation using household-level vehicle ownership data. In some examples, for each index, the stress items are derived from third-party data sources. Some of these sources include Epsilon marketing data, Equifax, Lexus/Nexus, the U.S. Department of Agriculture (USDA), crime statistics data from the Federal Bureau of Investigation (FBI), and so forth.

At step 407, a second communication interface receives data for applying data to the generalized health risk assessment models within the computing system. The process of applying patient-specific data to a generalized health risk assessment model is sometimes referred to as “building” the model for the patient. At step 408, a fourth communication interface receives data about patient encounters 210 of the particular patient. Using the data about the patient's encounters and data for the generalized health risk assessment models, the computing system builds 409 the generalized health risk assessment model for the specific patient.

In some implementations, the generalized health risk are trained before they are used to evaluate the health risk of patients. Training of the generalized health risk models involve using a set of patient cases. In some examples, the patient cases are directly reported to a third-party service provider by healthcare providers. In other examples, the patient cases are obtained from insurance claims for the purpose of evaluating generalized health risk. Some of these cases include chronic heart failure, total joint replacement, pneumonia, and so forth. The stressor indices are used with the patient cases to assess readmission events. For example, unscheduled, inpatient admission within a performance window constitute readmission events. In some implementations, the performance window is forty five days, during which time the goal of the system is to prevent or reduce readmission of the specific patient. In some other examples, the data elements used from the clinical data for the purpose of building the readmission risk model are limited to dates of admission, admission status, and diagnosis codes, to name a few. Training of the generalize health risk model also involves use of stress items or attributes of the socio-economic indices. For these indices, training is limited, in some cases, to non-clinical attributes that are not readily available in a clinical setting, with the exception of age, gender, name, and address. Also, data for each socio-economic index is segregated into exclusive sets applicable to the purpose of the index, for example, financial stability vs. family stability. This can be done, for example, to ensure that each index has as little crossover information value with other indices as possible.

The generalized health risk model utilizes validating and testing procedures. For example, validation and testing can be performed on a portion of the model, such as the portion applicable to readmission risk (risk that a patient will need to be readmitted to a hospital after he or she has been discharged). In this example, after training of the model, the model is validated using a hold-out set of patient cases that qualify for readmission reduction. A percentage of the patient cases, the validation set, is held out, e.g., twenty five percent of the qualified cases, for use in validating the readmission risk model after training. In some examples, the results of the validation set are evaluated based on accuracy of the predictions versus the actual results of the validation set using statistics such as Gini and Kolmogorov-Smirnov (KS) statistics. In other examples, the results of the validation are evaluated based on the accuracy of the model versus the expected accuracy based on the training results. Furthermore, the trained readmission risk model may be tested using an out of sample data set. For example, a data set that includes qualified visits to the provider that occurred in a time frame after the time frame of qualified visits used to train the model, or a data set outside the validation and training sets. These out of sample data sets may also be evaluated for accuracy as described above. A similar technique can be used for the other types of health risk (e.g., not be compliant with treatment protocols, fail to attend appointments with caregivers, not be adherent to prescription use, or other actions/omissions that affect the patient's well-being).

The health risk model is then evaluated for the specific patient case, using the data about the patient encounters 408.

At step 410, values for each stressor index used in the health risk model are determined. Values for each stressor index are determined by calculating values for each category of stressors, and each stressor index is assigned a value on the scale of 1-11 based on the index predictive power, derived by the index Gini coefficient derived from the training process.

At step 411, the health risk value is determined and stressor indices are ranked for the patient. Using the stressor index value for each index, aggregation of the index values is determined by a supervised additive segmentation algorithm. The algorithm aggregates the overall health risk based on both the clinical factors (clinical index) and socio-economic and demographic factors to generate the overall risk classification of the patient. Aggregation starts with the clinical index which may be produced by a third-party service provider, or by the provider (e.g., hospital). The clinical risk is the baseline risk level, and aggregation enhances the clinical risk differentiation. The clinical risk differentiation allows for better determination of which socio-economic stressor index, when applied to the clinical index, causes a higher health risk (e.g., risk of hospital readmission, risk that the patient will not adhere to medication, or other risk), thus allowing for each socio-economic stressor index to be ranked based on an ordered level of increase in clinical risk.

As one example, during the aggregation, when a stressor index, e.g., the transportation index is applied, the computing system 130 determines how the transportation index affects the health risk. As each stressor index is applied to the clinical index, the system may determine that that the transportation index increases the health risk by 60% while the stability index increases the health risk by 15%, and use this information in determining how to prioritize which index to address. Messages can be communicated to affect the higher-priority indices first, which is expected to affect health risk more significantly than if lower-priority indices were addressed first. In addition, if an index does not meet a threshold associated with the index (e.g., indicating that the index is within a tolerance), then the system may make a determination that the index does not need to be affected.

Aggregation of the index values is done by starting with the highest ranked socio-economic index (e.g., financial index, transportation index, food access index, and stability index) and cross-referencing the 1-11 ranks of both indices to establish 121 groups (11×11). For each group, risk is calculated and will provide a ranking level that ranks patients first on the aggregated risk and then, within each group, the clinical risk. This new re-ordering is smoothed to remove outlier groups with small sample sizes, and then the aggregated risk group is assigned a new 1-11 ranking. The process continues to aggregate each socio-economic index to the previous aggregated set. Once complete, the final 1-11 ranking represents the overall aggregation. Once the overall aggregation process is complete, utilization of the aggregation is established. The individual indices' 1-11 designations and prediction breakpoints are then organized to establish breakpoints and index combinations that define the 1-11 final aggregate health risk value that would be applied to any given patient.

At step 412, messages about actions to take for reducing stressor index values are sent to hospital devices. The computing system 130 transmits the messages to the fifth communication module 260 which sends the messages to the hospital devices 150. In some implementations, these messages may also be sent to patient devices.

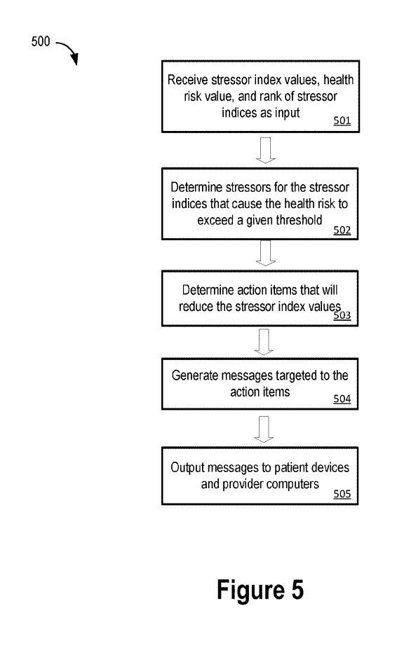

FIG. 5 is a flowchart 500 of a process for transmitting messages about actions for reducing stressor index values. At step 501, the fifth communication module receives the stressor index values, generalized health risk value, and a ranking of the stressor indices as input. The ranking of the stressor indices orders the stressor indices based on their impact on generalized health risk for a particular patient. For example, the stressor index that causes the largest increase in generalized health risk may receive the highest ranking, and the stressor index that causes the least increase in generalized health risk may receive the lowest ranking. Stressor indices at or below a specified threshold, e.g., below a certain ranking, may be removed from the list of stressor indices that should be modified.

At step 502, stressors for the stressor indices that cause the generalized health risk to exceed a given threshold are determined. In some examples, the threshold is based on the generalized health risk model 140 or any model to which the data representing the set of socio-economic and demographic characteristics of a specific patient was assigned. For example, if the transportation and food access indices were determined to cause the generalized health risk of a given patient to exceed the threshold, a list of stressors for the patient may include: food access, food quality, food cost, vehicle ownership, public transportation, auto loan availability, and so forth.

At step 503, action items that will reduce the stressor index values are determined. These action items include intervention programs and activities to be performed by the patient and the hospital or hospital staff. For example, for the patient whose generalized health risk exceeds a threshold because of transportation and food access stressors, the activities may include setting up meals-on-wheels delivery, providing grocery store coupons to the patient, setting up hospital shuttle pick-up services for the patient, providing the patient with information for auto loans, providing reminders to the patient for medications and food supplements, and so forth. In some examples, the computing system 130 may determine a work path that includes interview questions to confirm intervention programs and a work path of intervention activities and programs to present to the patient. In other implementations, the action items may help with patient discharge planning, case management processes, and post-discharge patient intervention actions all aimed at reducing generalized health risk.

At step 504, messages 280 targeted to these action items are generated for the particular patient. For example, a reminder message for a patient to take certain medications, a triage list for a particular patient of the socio-economic indices that drive an increase in the generalized health risk, a list of discharge instructions, and so forth. At step 505, the messages 280 are output to patient and provider devices 150.

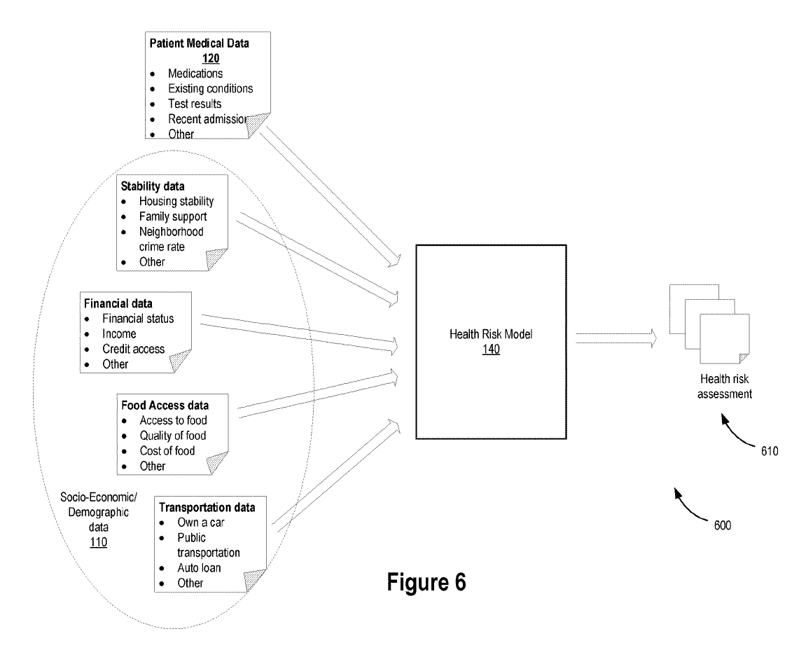

FIG. 6 is a block diagram 600 of model inputs to the generalized health risk model 140. The inputs may consist of patient medical data and socio-economic and demographic data 110 that includes stressors in different categories for determining stressor index values. In some instances, the patient medical data 120 includes medical attributes descriptive of a particular patient during admission, information in the medical records of a patient, and financial records of the patient that are available to the provider. For example, the patient medical data may include, medications the patient is currently taking, existing conditions, test results, recent admissions, and so forth.

The socio-economic and demographic data may include stability data, financial data, food access data, and transportation data. The stability data may include information about housing stability, family support, and neighborhood crime rate. The financial data may include information about financial status, income level, access to credit, and so forth. The food access data may include information about access to food, food quality, and food cost. The transportation data may include information about vehicle ownership, access to public transportation, access to auto loans and so forth. These are all used within the generalized health risk model 140 to determine generalized health risk assessment 610 for a particular patient.

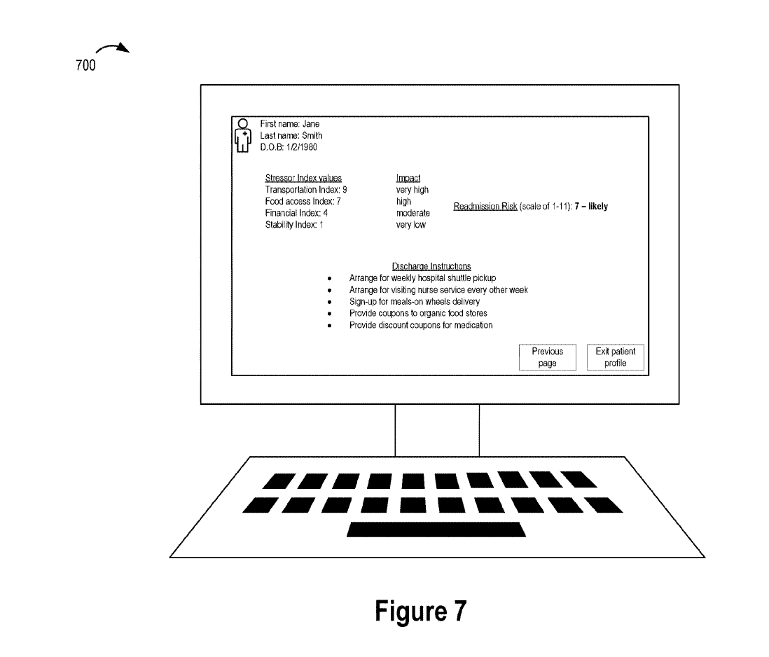

FIG. 7 represents a display 700 of output messages 280 of the computing system 130 to a provider device 150. The provider device 150 may be a desktop computer, a personal digital assistant (PDA), or a tablet that can receive information about patients from the computing system 130. For example, the provider device 150 may receive and display information about stressor index values for the stressor indices used to determine the generalized health risk of a particular patient. The example shown relates to readmission risk, but similar techniques could be used for other types of health risk (e.g., not be compliant with treatment protocols, fail to attend appointments with caregivers, not be adherent to prescription use, or other actions/omissions that affect the patient's well-being).

In some examples, the system 100 includes a processor that identifies information describing capabilities of the provider devices 150. This information may include device-specific parameters for the device that is to display the output messages 280. For example, the device-specific parameters may include features supported by the device or the device maker, information about the device make/model, whether the device is operating on a mobile or desktop platform, and so forth. In some examples, this information can be used by the system 100 to format messages 280 so that they can be depicted accurately on the display of the device 150. In some examples, this information can be used to determine messages 280 that are most likely to affect risk outcomes. For example, the system 100 may determine that a patient who has been discharged from a hospital uses a smartphone but not a laptop computer. In this example, the system 100 may use this information to identify SMS text messages to transmit to the patient's device, rather than email messages, because the patient may be more likely to read and react or respond to SMS text messages on a mobile device than email messages. As another example, the system 100 may determine that a patient uses a device that has calendar functionality, e.g., a calendar “app” on a smartphone, that accepts calendar invitation messages that, when accepted, cause an automatic creation of a calendar entry. In this example, the system 100 may make a determination to transmit calendar invitation messages for use with the patient's device, e.g., calendar invitations for physician checkups or prescription reminders, which the patient is more likely to use with the device's calendar functionality.

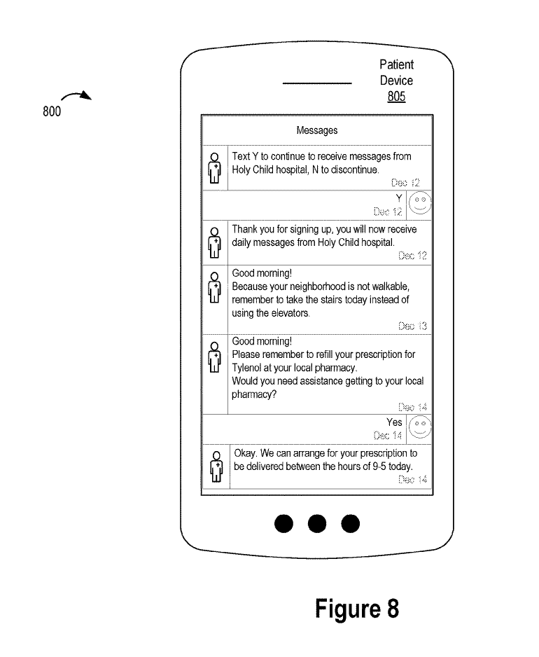

FIG. 8 represents a display 800 of output messages 280 of the computing system 130 to a patient device 805. The patient device may be a mobile device, a personal digital assistant (PDA), or a tablet that can receive messages 280 and information about from the computing system 130. For example, with the patient's permission, the patient device may receive periodic messages from the computing system about reminders to fill prescriptions, information about healthy lifestyle choices, appointment reminders, and so forth.

A message can be chosen for transmission based on a modifier value associated with the message, e.g., a modifier value quantifying an expected change in readmission risk of the patient if the message is transmitted and the information contained in the message displayed on a device used by the patient.

In some examples, system 100 may identify information that associates a device 805 with a patient and indicates that the device is available to the patient after discharge from the hospital. For example, system 100 may identify a patient's cell phone number and use that information to determine the cell phone carrier (e.g., T-Mobile, Sprint, Verizon, etc.) for the patient. Using this information, system 100 can choose messages 280 that are transmitted to the patient's device 805 in formats that allow them to be received by the device.

In some examples, system 100 includes a processor that identifies information describing capabilities of a patient device 805. This information may include device-specific parameters for the patient device 805 that is to receive and display output messages 280. For example, the device-specific parameters may include features supported by the patient device 805 or the device maker, information about the device make/model, whether the device is operating on a mobile or desktop platform, and so forth. Thus, the system 100 can format messages 280 so that they can be depicted accurately on the display of the patient device 805.

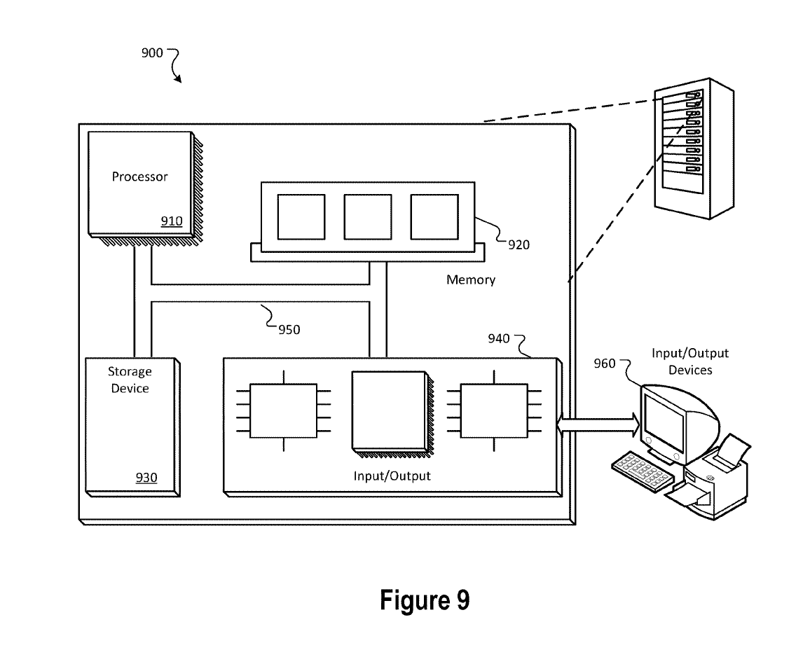

FIG. 9 is a block diagram of an example computer system 900. For example, referring to FIG. 2, the computing system 130 could be an example of the system 900 described here, as could the provider devices 150 shown in FIG. 1, and as could a computer system used by any of the users who access resources of the database of patient medical data 120, readmission risk model data 290, the database of socio-economic and demographic data 110, and the database of patient encounters 210 as shown in FIG. 2. The system 900 includes a processor 910, a memory 920, a storage device 930, and one or more input/output interface devices 940. Each of the components 910, 920, 930, and 940 can be interconnected, for example, using a system bus 950.

The processor 910 is capable of processing instructions for execution within the system 900. The term “execution” as used here refers to a technique in which program code causes a processor to carry out one or more processor instructions. In some implementations, the processor 910 is a single-threaded processor. In some implementations, the processor 910 is a multi-threaded processor. In some implementations, the processor 910 is a quantum computer. The processor 910 is capable of processing instructions stored in the memory 920 or on the storage device 930. The processor 910 may execute operations such as managing data communications of a hospital, including, for example, receiving data representing a model for predicting the impact of socio-economic and demographic factors on readmission risk, computing metrics of readmission risk for hospital patients, and identifying socio-economic or demographic characteristic associated with the metrics of readmission risk.

The memory 920 stores information within the system 900. In some implementations, the memory 920 is a computer-readable medium. In some implementations, the memory 920 is a volatile memory unit. In some implementations, the memory 920 is a non-volatile memory unit.

The storage device 930 is capable of providing mass storage for the system 900. In some implementations, the storage device 930 is a non-transitory computer-readable medium. In various different implementations, the storage device 930 can include, for example, a hard disk device, an optical disk device, a solid-date drive, a flash drive, magnetic tape, or some other large capacity storage device. In some implementations, the storage device 930 may be a cloud storage device, e.g., a logical storage device including one or more physical storage devices distributed on a network and accessed using a network, such as the network 270 shown in FIG. 2. In some examples, the storage device may store long-term data, such as patient medical data 120, data for the health risk model 290, socio-economic and demographic data 110, and data about patient encounters 210 as shown in FIG. 2. The input/output interface devices 940 provide input/output operations for the system 900. In some implementations, the input/output interface devices 940 can include one or more of a network interface devices, e.g., an Ethernet interface, a serial communication device, e.g., an RS-232 interface, and/or a wireless interface device, e.g., an 802.11 interface, a 3G wireless modem, a 4G wireless modem, etc. A network interface device allows the system 900 to communicate, for example, transmit and receive data such as patient medical data 120, data for the readmission risk model 290, socio-economic and demographic data 110, and data about patient encounters 210 as shown in FIG. 2, e.g., using the network 270 shown in FIG. 2. In some implementations, the input/output device can include driver devices configured to receive input data and send output data to other input/output devices, e.g., keyboard, printer and display devices 960. In some implementations, mobile computing devices, mobile communication devices, and other devices can be used.

The processes 300, 400, 500 shown in FIGS. 3, 4, and 5, can be realized by instructions that upon execution cause one or more processing devices to carry out the processes and functions described above, for example, computing metrics of readmission risk for hospital patients and identifying socio-economic or demographic characteristic associated with the metrics of readmission risk. Such instructions can include, for example, interpreted instructions such as script instructions, or executable code, or other instructions stored in a computer readable medium.

A computing system 130, database of patient medical data 120, a database of patient encounters 201, and a database of socio-economic and demographic data 110 as shown in FIGS. 1 and 2 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

In some examples, the system 900 is contained within a single integrated circuit package. A system 900 of this kind, in which both a processor 910 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 940.

Although an example processing system has been described in FIG. 9, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “system” may encompass all apparatus, devices, and machines for to processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server (e.g., a computing system 130, a database of patient medical data 120, a database of patient encounters 201, and a database of socio-economic and demographic data 110 as shown in FIGS. 1 and 2) is a general purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network such as the network 270 shown in FIG. 2. Examples of communication networks include a local area network (“LAN”) and a wide area network (“WAN”), e.g., the Internet.

A number of embodiments of the invention have been described. Nevertheless, it will be understood that various modifications may be made without departing from the spirit and scope of the invention. Accordingly, other embodiments are within the scope of the following claims.

What is claimed is:

1. A system for managing data communications for a healthcare provider, the system comprising:
a first communication module to receive data representing an identification of a particular patient;
a second communication module to receive data representing a model that predicts impact of socio-economic and demographic factors on readmission risk;
a third communication module to receive data from at least one system storing data representing a set of socio-economic and demographic characteristics of the particular patient;
a fourth communication module to receive data about encounters of the particular patient;
at least one processor to
assign, to the model that predicts the impact of socio-economic and demographic factors on health risk, at least some of the data representing the set of socio-economic and demographic characteristics of the particular patient;
based on the model, compute metrics of health risk for the particular patient;
identify at least one socio-economic or demographic characteristic associated with one of the metrics of health risk, the one of the metrics satisfying a risk threshold associated with that metric, the risk threshold being based on the model to which the data representing the set of socio-economic and demographic characteristics of the particular patient was assigned; and
a fifth communication module to automatically transmit data representing at least one message related to the identified at least one socio-economic or demographic characteristic to cause a recipient of the message to take an action to affect the one or more socio-economic and demographic factors.

2. The system of claim 1, comprising at least one processor configured for:
identifying information describing capabilities of one or more electronic devices associated with a healthcare provider associated with the particular patient; and
formatting the message based on information describing the capabilities of at least one of the electronic devices.

3. The system of claim 1, comprising at least one processor configured for
determining, based on the model, a modifier value that, when applied to the metric of the socio-economic or demographic characteristic, would alter the relationship between the metric and the threshold; and
selecting the message based on the data associating the at least one message with the modifier value.

4. The system of claim 3, comprising
at least one processor configured for determining that the modifier value is associated with data of the model representing an activity of the particular patient designated as occurring after the particular patient is discharged from a hospital;
identifying information describing capabilities of an electronic device associated with the particular patient, the electronic device associated with data designating the electronic device as available to the particular patient;
formatting the message based on information describing the capabilities of the electronic device available to the particular patient.

5. The system of claim 4, wherein the fifth communications module is configured to transmit the message to the electronic device available to the particular patient.

6. The system of claim 1, wherein the third communication module is configured to transmit information describing a location of residence of the particular patient to the at least one system storing data representing the set of socio-economic and demographic characteristics.

7. The system of claim 1, wherein the processor is configured to:
calculate a generalized health risk assessment value based on the metrics of risk for the particular patient;
determine that the generalized health risk assessment value satisfies a threshold of unacceptable generalized health risk;
identify, among the metrics of generalized health risk for the particular patient, at least one of the metrics of generalized health risk having a value that, if altered, would alter the generalized health risk assessment value such that the generalized health risk assessment value would satisfy a threshold of acceptable generalized health risk; and
select one of the at least one metrics of generalized health risk as the metric satisfying the risk threshold associated with that metric.

8. The system of claim 1, wherein the health risk includes at least one of risk of hospital readmission, risk of non-compliance with treatment protocols, risk of failure to attend appointments with caregivers, or risk of non-adherence to prescription use.

9. A method comprising:
receiving, by one or more processors of a system for managing communications with hospital patients, information identifying a patient, the information being received in response to a request by a provider;
receiving, by the one or more processors, demographic and socio-economic attributes for patients from a socio-economic and demographic database;
matching, by the one or more processors, the demographic and socio-economic attributes with the information identifying the patient to determine data representing a set of demographic and socio-economic attributes of the patient;
determining, by the one or more processors, metrics of readmission risk for the patient, based on applying the data representing the set of demographic and socio-economic attributes of the patient to a model for determining readmission risk;
comparing, by the one or more processors, the metrics of readmission risk with risk threshold values that specify unacceptable readmission risk;
selecting, by the one or more processors, one or more demographic and socio-economic attributes associated with one of the metrics of readmission risk, the one or more metrics meeting the risk threshold value associated with the metric, the risk threshold value being based on the model for determining readmission risk; and
transmitting, by the one or more processors, information about the selected attributes to the provider.

10. The method of claim 9, comprising using the model for readmission risk to generate values of socio-economic stressor indices, wherein the system aggregates the values with clinical risk indices to determine risk values.

11. The method of claim 10, wherein the socio-economic stressor indices are determined based on stress items, the stress items being used within the model to determine values of the socio-economic stressor indices, and the stress items being assigned to a category corresponding to a stressor index.

12. The method of claim 10, wherein the socio-economic stressor indices comprise one or more of a stability index, a financial index, a food access index, or a transportation index.

13. The method of claim 9, wherein data about encounters of the patient is received by a fourth communication interface and applied with data received about the model to build the readmission risk model for the patient.

14. The method of claim 10, wherein the values of the socio-economic stressor indices are on a scale of 1-11, with 1 indicating the lowest likelihood of readmission, and 11 indicating the highest likelihood of readmission.

15. The method of claim 9, comprising determining an overall readmission risk for the patient based on clinical factors and demographic and socio-economic attributes.

16. The method of claim 15 wherein the clinical factors are used to determine a clinical index, the clinical index being a baseline index used to order patients by risk, and to set breakpoints that define risk groups on a scale.

17. The method of claim 16, wherein socio-economic stressor indices are ranked based on an ordered level of increase in clinical risk when corresponding socio-economic factors are applied to the clinical index.

18. The method of claim 15, comprising:
identifying stress items that cause the overall readmission risk to exceed a predetermined threshold; and
determining action items for reducing values of stressor indices that correspond to the stress items.

19. The method of claim 9, comprising transmitting, messages about actions to take for reducing stressor indices to hospital and patient devices.

20. A method comprising:
receiving, by one or more processors of a system for managing communications with hospital patients, information identifying a patient, the information being received in response to a request by a provider;
receiving, by the one or more processors, demographic and socio-economic attributes for patients from a socio-economic and demographic database;
matching, by the one or more processors, the demographic and socio-economic attributes with the information identifying the patient to determine data representing a set of demographic and socio-economic attributes of the patient;
determining, by the one or more processors, metrics of health risk for the patient, based on applying the data representing the set of demographic and socio-economic attributes of the patient to a model for determining health risk;
comparing, by the one or more processors, the metrics of health risk with risk threshold values that specify unacceptable health risk;
selecting, by the one or more processors, one or more demographic and socio-economic attributes associated with one of the metrics of health risk, the one or more metrics meeting the risk threshold value associated with the metric, the risk threshold value being based on the model for determining health risk; and
transmitting, by the one or more processors, information about the selected attributes to the provider;
wherein the health risk includes at least one of risk of hospital readmission, risk of non-compliance with treatment protocols, risk of failure to attend appointments with caregivers, or risk of non-adherence to prescription use.
